(19) United States
(12) Patent Application Publication
(10) Pub. No.: US 2008/0153685 A1
(43) Pub. Date: Jun. 26, 2008

(54) Dunnage Conversion System and Method with Cohesive Stock Material

(75) Inventors: Robert C. Cheich, Independence, OH (US); Judith L. Skiba, Kingsville, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: Ranpak Corp., Concord Township, OH (US)

(21) Appl. No.: 11/814,875

(22) PCT Filed: Jan. 26, 2006
(86) PCT No.: PCT/US2006/002785

§ 371 Date: Jul. 26, 2007

Related U.S. Application Data
(60) Provisional application No. 60/647,172, filed on Jan. 26, 2005.

(51) Int. Cl. B31D 5/00; B65D 65/38; B65D 81/05; B31F 1/20; B31F 7/00

(52) U.S. Cl. 493/381; 493/464; 493/394

(57) ABSTRACT

A method of making a dunnage product from a continuous length of stock material having a cohesive on at least one surface thereof comprises the step of converting the stock material into a relatively less dense configuration with at least two cohesive portions of the stock material being attached together.

This application claims the benefit of U.S. Provisional Patent Application No. 60/647,172, filed Jan. 26, 2005, the entire disclosure of which is hereby incorporated herein.

### FIELD OF THE INVENTION

This invention relates generally to a dunnage conversion system and method, and more particularly to a dunnage conversion system and method of converting a stock material into a dunnage product.

### BACKGROUND

Dunnage products are commonly used in containers to fill voids and/or cushion an article during transport. Converters heretofore have been used to convert a stock material into a dunnage product as it is needed. Dunnage converters typically draw a sheet stock material from a roll or fan-folded stack for conversion into a dunnage product, such as cushioning, void fill or a wrap. Exemplary dunnage converters are disclosed in U.S. Pat. Nos. 4,968,291; 5,123,889; and 6,676,589. The thus-produced dunnage product can be used as is, or it can be further manipulated, e.g., wound into a coil, to meet different packaging needs. An exemplary coiling apparatus is disclosed in U.S. Pat. No. 6,626,813. The entire disclosures of these patents are hereby incorporated herein.

### SUMMARY

The present invention provides a system and method for making a dunnage product from a stock material having a cohesive on at least one surface. A cohesive, unlike an adhesive, only attaches to itself and generally will not stick to other items, such as non-cohesive-coated portions of the stock material or a conversion machine. As a result, a system and method for making a dunnage product from such a stock material can provide a dunnage product with different characteristics than non-cohesive stock material.

More particularly, the present invention provides a method of making a dunnage product from a stock material having a cohesive on at least one surface thereof. The method comprises the step of converting the stock material into a relatively less dense configuration with at least two cohesive portions of the stock material being attached together to maintain the less dense configuration of the dunnage product. A plurality of superimposed plies of sheet stock material, such as paper, can be used as long as at least one ply includes a cohesive on at least one surface thereof. The stock material can be provided as a roll or a fan-folded stack.

The present invention also provides a combination of a dunnage conversion machine and a supply of stock material that includes a stock material having a cohesive on at least one surface thereof. The conversion machine draws the stock material into the machine for conversion into the dunnage product, with at least two cohesive portions of the stock material being brought together.

According to another aspect of the invention, a length of a dunnage product having a cohesive exposed on a surface thereof is wound into a coil such that cohesive portions on mutually facing surfaces are brought together to hold the dunnage product in a coiled configuration.

The foregoing and other features of the invention are hereinafter fully described and particularly pointed out in the claims, the following description and the annexed drawings setting forth in detail plural illustrative embodiments of the invention, such being indicative, however, of but a few of the various ways in which the principles of the invention may be employed.

### BRIEF DESCRIPTION OF THE DRAWINGS

FIG. 1 is a schematic representation of a system in accordance with the present invention.

FIG. 2 is a perspective view of a roll of sheet stock material for use in the system of FIG. 1.

FIG. 3 is a schematic side view of a multi-ply fan-folded sheet stock material for use in the system of FIG. 1.

FIG. 4 is a perspective view of a dunnage conversion machine that can be used in the system of FIG. 1.

FIG. 5 is a schematic plan view of the internal components of the dunnage conversion machine of FIG. 4.

FIG. 6 is a side elevation view of another dunnage conversion machine that can be used in the system of FIG. 1, with the housing of the dunnage conversion machine partially removed to show the internal components of the dunnage conversion machine.

FIG. 7 is a side elevation view of yet another dunnage conversion machine that can be used in the system of FIG. 1, with the housing of the dunnage conversion machine partially removed to show the internal components of the dunnage conversion machine.

FIG. 8 is a schematic plan view of an exemplary fan-foldable sheet stock material having a cohesive on a surface thereof.

FIG. 9 is a side view of the stock material of FIG. 8 partially folded.

FIG. 10 is a side view of a length of dunnage produced from the stock material shown in FIG. 8 as might be produced by the dunnage conversion machine shown in FIGS. 4 and 5.

FIG. 11 is a perspective view of a pair of fan-folded stacks of sheet stock material that can be spliced together.

FIG. 12 is a perspective view of a dunnage product as might be produced by the dunnage conversion machine shown in FIG. 7.

FIG. 13 is a side view of coiler in accordance with the system of FIG. 1 for producing a coiled dunnage product produced by the dunnage conversion machine shown in FIG. 7.

FIG. 14 is a perspective view of a coiled dunnage product.

### DETAILED DESCRIPTION

The present invention provides an improved system and method for making a dunnage product from a stock material having a cohesive on at least one surface thereof. The cohesive provides benefits in converting the stock material into a dunnage product, using the dunnage product to pack one or more articles in a container, or enhances one or more properties of the dunnage product to provide different performance characteristics in comparison to a dunnage product without the cohesive material.

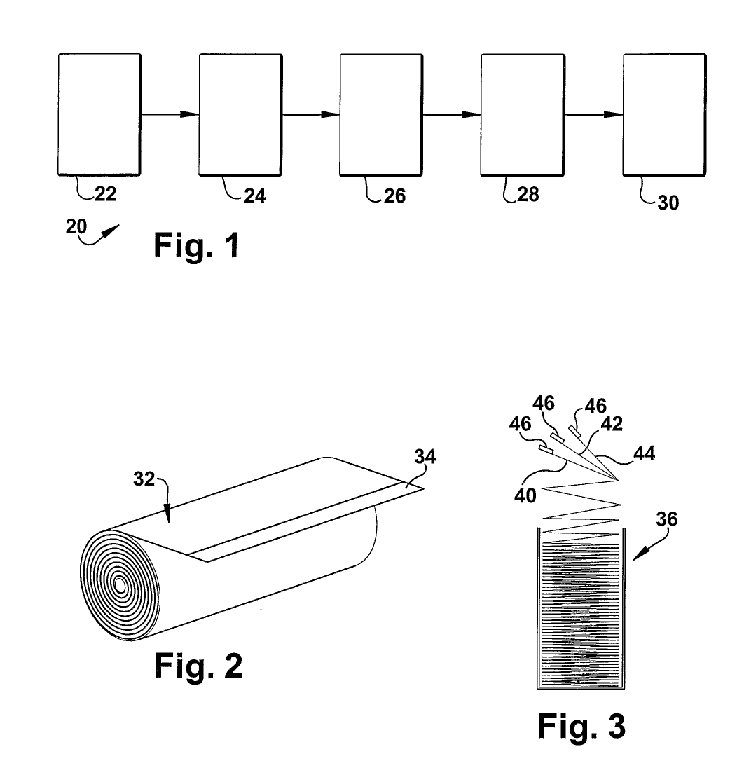

Referring now specifically to the drawings, FIG. 1 shows a schematic representation of a system 20 in accordance with the present invention that includes the combination of a supply of stock material 22 having a cohesive on at least one surface thereof and a dunnage conversion machine 24 that converts the stock material into a relatively less dense dunnage product 26. Instead of the stock material being pre-coated with a cohesive, the dunnage conversion machine can apply the cohesive in the course of converting the stock material into a dunnage product. In the conversion process, the conversion machine 24 typically joins at least two cohesive portions of the stock material together. The system 20 can further include a coiler 28 that receives a length of the dunnage product 26 from the conversion machine 24 and winds the dunnage product 26 into a coil 30, thereby bringing at least two portions of cohesive together to minimize or to prevent uncoiling of the coiled dunnage product 30 produced by the coiler 28. The coiler 28 would be omitted in a system that produces dunnage not suitable for coiling, of course.

Turning now to some more specific examples of the various components of the system, FIGS. 2 and 3 show exemplary forms of the supply of stock material 22 of FIG. 1. While discrete pieces of stock material could be used to produce the dunnage product in accordance with the invention, typically it is preferable to convert a continuous stock material into dunnage products. The illustrated supply of stock material includes a continuous sheet stock material, such as paper or plastic, having one or more plies, with a cohesive on a surface of at least one ply. An exemplary supply of stock material includes a single continuous sheet with a cohesive coating an entire surface thereof.

The cohesive can stiffen the stock material and the resulting dunnage product and/or increase its strength. The cohesive stock material can be converted by a conventional dunnage conversion machine, such as those described below. Various components of the dunnage conversion machine can be coated with a low-friction coating or replaced with low friction materials, such as nylon, to minimize or eliminate cohesive material being removed from the stock material during the conversion process.

The cohesive, additionally or alternatively, can be selected to provide or enhance one or more properties of the dunnage product. The cohesive can function to provide a stiffer dunnage product, for example. The cohesive also can provide benefits in the use of the resulting dunnage product, such as to hold multiple dunnage products together or spaced-apart portions of a strip of dunnage together in a particular orientation, such as a coil. Unlike prior methods of holding a dunnage product in a coiled configuration, no heat or supplementary closure materials, such as adhesive glue, mechanical staples, tape or other bonding strips, for example, are necessary in view of the cohesive.

In FIG. 2, the sheet stock material 32 is provided in the form of a roll having a cohesive strategically disposed on at least a leading end of the sheet. In FIG. 3, the sheet stock material is provided in the form of a fan-folded stack 36. The illustrated stack of stock material has multiple plies 40, 42, and 44 with a cohesive 46 on at least one surface of at least one ply. In the illustrated stock material, the cohesive 46 is on a surface at a leading end of each ply. Alternatively, as noted above, the stock material can have a cohesive over an entire surface. Another supply of sheet stock material is shown in FIG. 7, wherein sheet stock material is supplied to a dunnage converter from multiple single-ply stacks 37, 38 and 39, effectively providing a multi-ply stock material. One or more of these stacks includes a stock material having a cohesive thereon.

Generally, the stock material has a cohesive on a surface of the stock material at locations other than or in addition to at the leading edge thereof. The cohesive on the surface of the stock material generally is located so that different portions of cohesive do not come into contact with each other in the supply, as will be discussed in more detail below. The stock material is drawn from the supply 22 (FIG. 1) into a dunnage conversion machine 24 (FIG. 1) for conversion into a dunnage product 26 (FIG. 1).

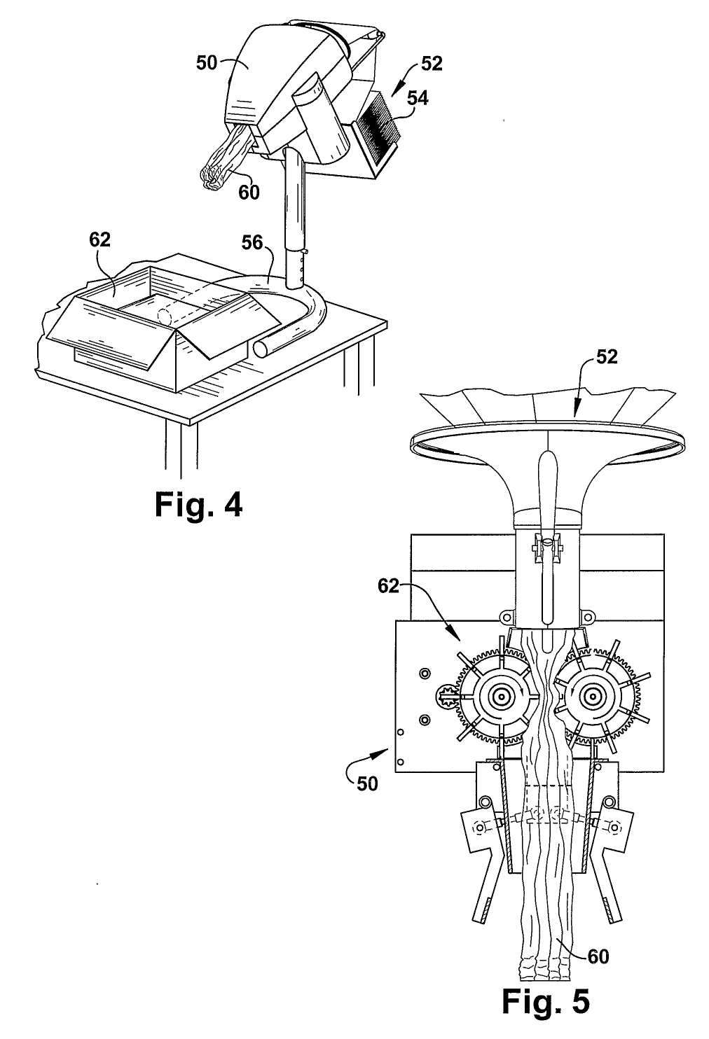

FIGS. 4-7 illustrate several exemplary dunnage conversion machines and the dunnage products produced thereby for use in the system 20 shown in FIG. 1. Referring initially to FIGS. 4 and 5, a dunnage conversion machine 50 in combination with a supply of stock material 52 in the form of a continuous fan-folded stack of single-ply sheet stock material 54 is shown mounted on a stand 56 for conversion of the stock material into a void-fill dunnage product 60. The stand 56 positions the conversion machine 50 to dispense the dunnage product 60 in a continuous strip into a container 62 to fill the voids around an article packed in the container 62. As shown in FIG. 5, the conversion machine 50 includes a feeding assembly 64 that draws the stock material 52 from the supply 52 (FIG. 4), causing the stock material to be inwardly gathered and randomly crumpled to form the dunnage product 60.

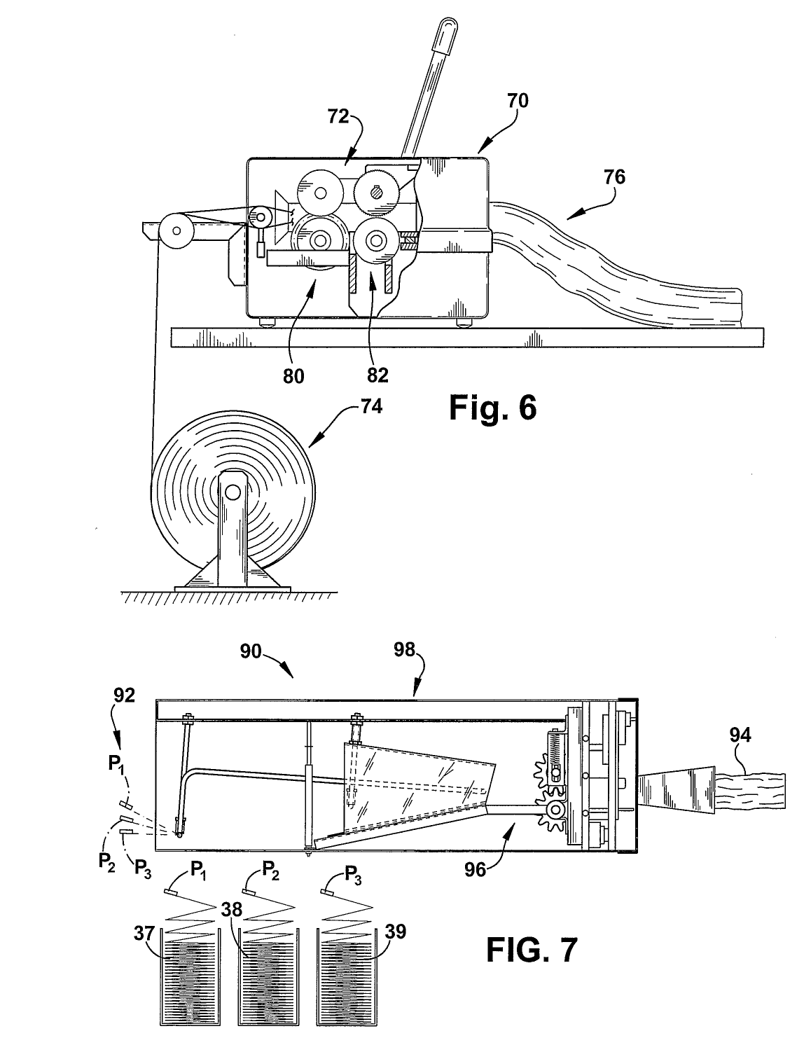

Another type of dunnage conversion machine 70 is shown in FIG. 6. The dunnage conversion machine 70 also includes a feeding assembly 72 that draws a continuous sheet stock material from a supply 74 thereof, in this case in roll form, and causes the stock material to be randomly crumpled to form a dunnage product 76. In this conversion machine the stock material is laterally and longitudinally crumpled as it passes through upstream and downstream sets 80, 82 of rotating members operating at different speeds.

Finally, a cushioning dunnage conversion machine 90 is shown in FIG. 7 that converts a continuous multi-ply sheet stock material 92 (having plies P1, P2 and P3) into a strip of dunnage 94 from which discrete cushioning dunnage products can be separated. The conversion machine 90 includes a feeding assembly 96 that draws the sheet stock material 92 from a supply thereof and causes the stock material to be randomly crumpled. In the process, lateral portions of the sheet stock material are turned inwardly and the stock material is randomly crumpled as the feeding assembly 96 draws the stock material through a forming assembly 98. The feeding assembly 96 then connects multiple layers of stock material by coining the crumpled stock material as it is drawn therethrough.

Each of these exemplary dunnage conversion machines 50 (FIG. 4), 70 (FIG. 6), 90 (FIG. 7) include assemblies that cause the stock material to randomly crumple in one fashion or another and thereby produce a relatively less dense crumpled dunnage product. The cohesive can help the resulting dunnage product maintain its crumpled state. Cohesive portions that are brought together in the conversion process stick together and thereby help the dunnage product 60 hold its shape. The dunnage product also can be manipulated, e.g. folded, coiled, etc., into a desired shape where cohesive portions can help to hold the dunnage product in a desired configuration. Respective cohesive portions that are brought together during or after the conversion process bind with one another when they come into contact with one another, thereby helping the resulting dunnage product maintain its shape.

The cohesive also can facilitate or improve the conversion process. In the cushioning conversion machine 90 shown in FIG. 7, for example, by using a cohesive on the stock material less pressure needs to be generated by the coining elements of the feeding assembly 96 to help the resulting crumpled dunnage product 94 maintain its shape. For further details regarding the operation of a particular dunnage conversion machine, reference can be made to the aforementioned U.S. Pat. Nos. 4,968,291; 5,123,889; and 6,676,589. The cohesive stock material can be advantageous in many different types of dunnage conversion machines, however, and the present invention is not limited to these dunnage conversion machines or their use.

Returning to a discussion of the supply 22 of cohesive stock material used in this system 20 (FIG. 1), although the cohesive can be applied to cover an entire surface of the stock material, in general it is desirable to apply the cohesive such that different cohesive portions do not come into contact with one another before being brought together by a dunnage conversion machine 24 (FIG. 1). In a fan-folded stack, for example, pairs of adjacent pages of the stock material are folded so that their surfaces face one another. If the stock material were continuously coated with a cohesive on this surface, the facing portions would engage one another and stick together. Consequently, in a supply of stock material having a fan-folded configuration, the cohesive typically is strategically applied so that the pages do not stick together. Similar considerations apply to other forms of stock material, including the rolled stock material 32 shown in FIG. 2; facing surfaces of the stock material in the supplied configuration generally do not have cohesive portions thereon that overlie other cohesive portions.

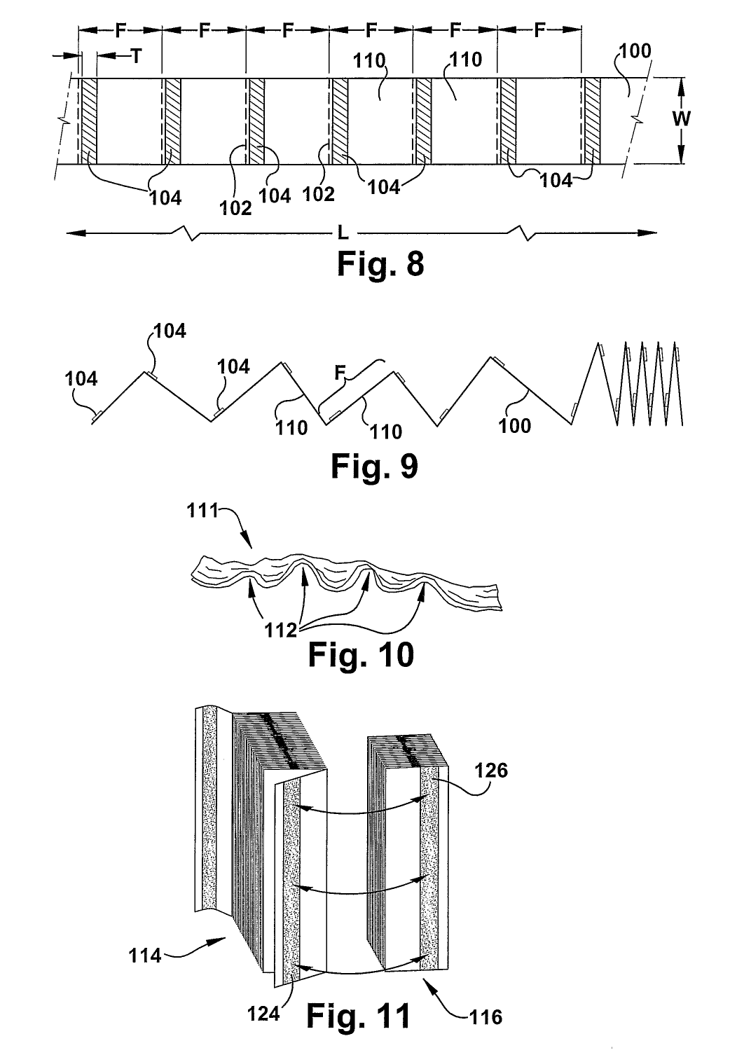

Referring now to FIGS. 8 and 9, a length of a continuous fan-foldable sheet stock material 100 is shown that has strategically applied cohesive on a surface thereof. The stock material 100 has a longitudinal or length dimension L and a transverse or width dimension W. The stock material 100 also has a plurality of longitudinally-spaced transversely-extending fold lines 102 characteristic of a fan-folded stock material, and a plurality of strategically-applied cohesive portions 104 on an upper surface 106 thereof. The fold lines 102 divide the length of the stock material into a plurality of rectangular pages 110 having a dimension F in the longitudinal direction. One or more fold lines can include perforations to facilitate separating a dunnage product from the unconverted stock material.

The stock material 100 shown in FIGS. 8 and 9 has a plurality of regularly-spaced, transversely-extending strips of cohesive 104 that are offset from the fold lines 102. Additionally, each strip of cohesive 104 has a relatively narrow dimension T in the longitudinal direction (width in the longitudinal direction) relative to the longitudinal dimension F of each page 110. The size and position of the strip 104 on each page 110 is selected to prevent cohesive portions 104 on the surfaces of mutually-facing pages 110 from coming into contact with one another when the stock material 100 is placed in a fan-folded configuration.

If this stock material 100 is converted into a dunnage product by a conversion machine, such as the dunnage conversion machine 50 of FIG. 4, the resulting dunnage product 111 is shown in FIG. 10. The dunnage product 111 has a plurality of longitudinally-spaced secured portions 112 where inwardly gathered cohesive portions help the dunnage product 111 retain its crumpled state.

As shown in FIGS. 2 and 3, often it is beneficial for each ply of a sheet stock material to have a cohesive on a surface of a leading end thereof and on an opposing surface on a trailing end thereof to facilitate splicing an almost-spent supply of stock material to a new supply of stock material. As noted above, the cohesive can extend to or be strategically applied on other areas of the stock material as well. The supplies of stock material 32, 36 shown in FIGS. 2 and 3 have a cohesive 34, 46 on a leading end of one or more plies of the stock material.

FIG. 11 shows two stacks 114, 116 of fan-folded stock material that have respective cohesive portions 124, 126 exposed thereon such that one stack 114 can be placed atop another 116, whereby the leading and trailing ends of the respective stacks can be spliced together by the respective portions of cohesive. A cohesive, moreover, generally does not stick to anything other than another cohesive, and this simplifies handling the stock material prior to splicing as well. Splicing generally minimizes or eliminates machine downtime in replenishing and maintaining the continuity of the supply of stock material, and can be accomplished with rolled stock material as well, although generally not until the trailing end of the almost-spent supply comes off the core around which the stock material typically is wound.

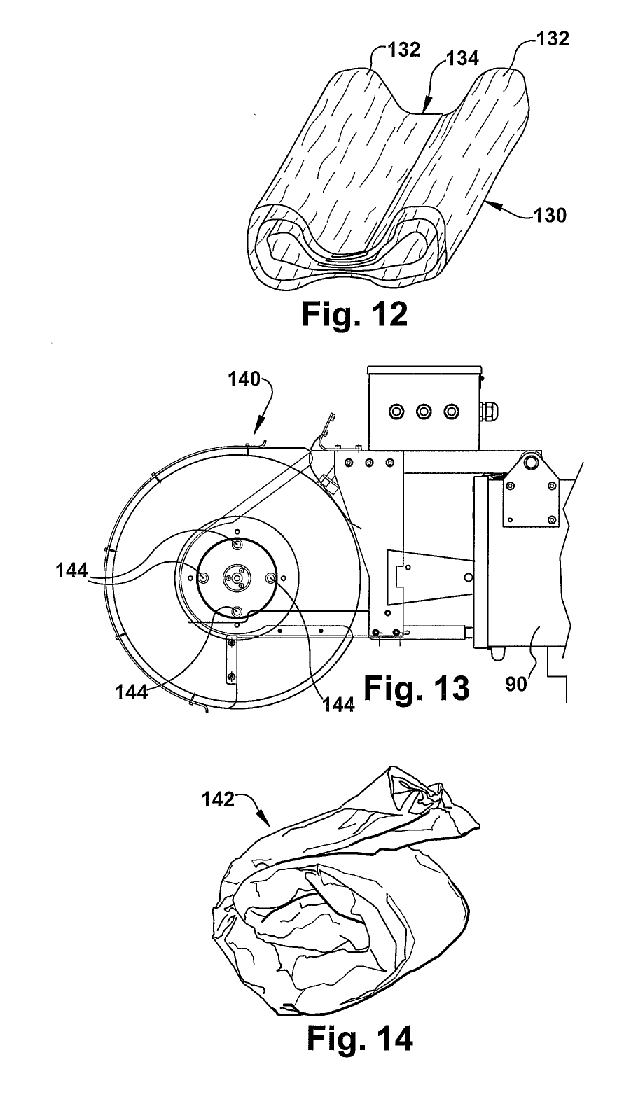

Other arrangements of cohesive on the stock material also are possible. The cohesive can be provided in regularly or irregularly spaced, sized, oriented or shaped strips or patterns of cohesive on one or more surfaces of the stock material. For example, longitudinal disposed portions of cohesive at lateral edges of the stock material can be used to connect the overlapped lateral edges of the crumpled stock material in the cushioning conversion machine 90 shown in FIG. 7. A resulting dunnage product 130 is shown in FIG. 12 that has lateral pillow portions 132 and a central connected portion 134 that includes the overlapped lateral portions of the multi-ply sheet stock material held together by respective confronting cohesive portions on lateral portions of the sheet stock material.

As should be apparent by now, the cohesive can be applied to the stock material in any manner that facilitates the conversion process or provides desired qualities in the resulting dunnage product. The cohesive generally is placed on a surface of the stock material such that upon conversion different portions of cohesive can be brought together to secure the dunnage product, or upon conversion cohesive portions are exposed on the surface of the dunnage product such that further manipulation of the dunnage product, via a coiler, for example, can make use of the exposed cohesive to provide the desired properties in the resulting dunnage product.

As mentioned above, a dunnage product 26 produced by a dunnage conversion machine 24 can be manipulated into a desired shape and held in place by the cohesive, e.g. coiled by the coiler 28 in the system 20 shown in FIG. 1. A coiler 140 is shown in FIG. 13 adjacent the dunnage conversion machine 90 shown in FIG. 7, and a coiled dunnage product 142 is shown in FIG. 14. The coiler is described in the aforementioned U.S. Pat. No. 6,626,813. The dunnage product 142 preferably has a cohesive on a surface thereof such that upon being coiled at least two portions of cohesive are brought together to secure the strip in its coiled configuration and thereby minimize or prevent uncoiling of the coiled dunnage product. The cohesive can secure each winding of the coil to an adjacent winding or can secure an outer winding to an adjacent inner winding. Note that although the coiler shown and described in the aforementioned patent includes a pair of coiling tines or forks around which the dunnage product is wound, the illustrated coiler 140 includes four tines or forks 144 equally circumferentially spaced. The four-fork coiler 140 can provide a larger coil from a dunnage product of the same length, and also provides a coil having greater loft at the center of the coil. This might be particularly desirable for applications that require more dunnage toward an outer portion of the coil than at the center of the coil.

The present invention thus provides a system and method for using a cohesive stock material to make and use a dunnage product. The cohesive can improve characteristics of the dunnage product, help to maintain the crumpled dunnage product in its crumpled state, or help to maintain a configuration of the dunnage product relative to itself or other dunnage products.

Although the invention has been shown and described with respect to certain illustrated embodiments, equivalent alterations and modifications will occur to others skilled in the art upon reading and understanding the specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer that performs the specified function (i.e., that is functionally equivalent), even though not structurally equivalent to the disclosed structure that performs the function in the herein illustrated embodiments of the invention. In addition, while a particular feature of the invention might have been described above with respect to only one of several illustrated embodiments, such a feature can be combined with one or more other features of another embodiment, as might be desired and advantageous for any given or particular application.

What is claimed is:

1. In combination, a supply of stock material and a dunnage conversion machine that converts the stock material into a relatively less dense dunnage product, wherein the supply includes a stock material having a cohesive material on at least one surface thereof, and the conversion machine causes at least two cohesive portions of the stock material to come together whereby the cohesive portions bind to each other.

2. A combination as set forth in any preceding claim, wherein the conversion machine joins at least two portions of the stock material together via the cohesive.

3. A combination as set forth in any preceding claim, further comprising a coiler that receives a dunnage product from the conversion machine and winds the dunnage into a coil, thereby bringing at least two portions of cohesive together to minimize or to prevent uncoiling of the coiled dunnage product.

4. A combination as set forth in any preceding claim, wherein the resulting dunnage product has cohesive on an exposed surface thereof.

5. A combination as set forth in the preceding claim, wherein the sheet stock material includes at least one of paper and a plastic.

6. A combination as set forth in any preceding claim, wherein the conversion machine includes an assembly that brings lateral edges of a sheet stock material inward.

7. A combination as set forth in any preceding claim, wherein the conversion machine includes a feed assembly that draws the stock material from the supply.

8. A combination as set forth in any preceding claim, wherein the conversion machine includes rotating members that draw the stock material into the conversion machine.

9. A combination as set forth in any preceding claim, wherein the supply of stock material includes a continuous sheet stock material in the form of a roll or a fan-folded stack.

10. A combination as set forth in any preceding claim, wherein the supply of stock material includes a plurality of superimposed plies of sheet stock material, at least one of which has a cohesive on a surface thereof.

11. A combination as set forth in the preceding claim, wherein each ply of sheet stock material has a cohesive on a surface of a leading end thereof and on an opposing surface on a trailing end thereof to facilitate splicing an almost-spent supply of stock material to a new supply of stock material.

12. A combination as set forth in any of claims 10 and 11, wherein the supply of sheet stock material includes a plurality of regularly longitudinally-spaced cohesive portions.

13. A combination as set forth in any of claims 10 to 12, wherein the supply of sheet stock material is provided in a fan-folded stack, and a regularly longitudinally-spaced cohesive is provided offset from fold lines in the stock material such that cohesive portions on facing surfaces of the stock material in the fan-folded state do not overlie one another.

14. A method of making a dunnage product from a stock material having a cohesive on at least one surface thereof, comprising the step of:
converting the stock material into a relatively less dense configuration with at least two cohesive portions of the stock material being attached together.

15. A method as set forth in claim 14, wherein the step of providing the stock material includes the steps of providing a plurality of superimposed plies of a sheet stock material.

16. A method as set forth in claim 15, wherein the step of providing a plurality of superimposed plies includes the step of providing a plurality of plies made of paper, at least one of which includes a cohesive material.

17. A method as set forth in any of claims 14 to 16, wherein the step of providing a stock material includes providing a fan-folded stack of stock material.

18. A method as set forth in any of claims 14 to 17, wherein the step of converting the stock material into a dunnage product includes the steps of inwardly turning lateral edges of the stock material to form a continuous strip having a pair of lateral plural-like portions in a central band therebetween.

19. A method as set forth in the previous claim, wherein the step of converting the stock material into the dunnage product includes the step of coining the central band.

20. A stock material for use with a dunnage conversion machine comprising a plurality of superimposed plies of sheet material, at least one surface of at least one ply having a cohesive thereon.

21. A stock material as set forth in claim 20, wherein the superimposed plies are configured as a multi-ply roll of stock material or as a multi-ply fan-folded stack.

22. A stock material as set forth in any of claims 20 and 21, wherein the superimposed plies are fan-folded into a stack, the superimposed plies including a series of alternating fold which each create superimposed creases through the plies, and the series of folds together forming a sequence of rectangular pages that are piled accordion-style one on top of the other to form the stack.

23. A stock material as set forth in any of claims 20 to 22, wherein at least one of the plies is made of a material selected from a group consisting of kraft paper, printed paper, bleached paper, tissue paper and combinations thereof.

24. A method of making a dunnage product comprising the following steps: converting a stock material having a cohesive on at least one part thereof into a strip of dunnage such that at least two portions of the cohesive are exposed, and then coiling the strip such that the two or more cohesive portions engage one another to maintain the strip in a coil.
